(19) United States
(12) Patent Application Publication
(10) Pub. No.: US 2025/0148678 A1
(43) Pub. Date: May 8, 2025

(54) HUMAN SUBJECT GAUSSIAN SPLATTING USING MACHINE LEARNING

(71) Applicant: Apple Inc., Cupertino, CA (US)

(72) Inventors: Anurag RANJAN, Sunnyvale, CA (US); Muhammed KOCABAS, Seattle, WA (US); James C. GABRIEL, Seattle, WA (US); Jen-Hao CHANG, Santa Clara, CA (US); Cuneyt O. TUZEL, Cupertino, CA (US)

(21) Appl. No.: 18/653,917

(22) Filed: May 2, 2024

Related U.S. Application Data
(60) Provisional application No. 63/595,751, filed on Nov. 2, 2023.

(51) Int. Cl. G06T 13/40; G06T 7/579; G06T 7/70; G06T 17/20

(52) U.S. Cl. CPC G06T 13/40; G06T 7/579; G06T 7/70; G06T 17/20; G06T 2207/20081; G06T 2207/30196; G06T 2210/56

(57) ABSTRACT

Aspects of the subject technology provide for human subject Gaussian splatting using machine learning. A method includes receiving a video input having a scene and a subject. The method also includes obtaining a three-dimensional (3D) reconstruction of the subject and the scene from the video input. The method includes generating a 3D Gaussian representation of each of the scene and the subject. The method also includes generating a deformed 3D Gaussian representation of the subject by adapting the 3D Gaussian representation of the subject to the 3D reconstruction of the subject. The method includes rendering a visual output comprising an animatable avatar of the subject and the scene using differentiable Gaussian rasterization based at least in part on the deformed 3D Gaussian representation of the subject and the 3D Gaussian representation of the scene.

### CROSS-REFERENCE TO RELATED APPLICATION(S)

This application claims the benefit of U.S. Provisional Application Ser. No. 63/595,751, entitled “HUMAN SUBJECT GAUSSIAN SPLATTING USING MACHINE LEARNING,” and filed on Nov. 2, 2023, the disclosure of which is expressly incorporated by reference herein in its entirety.

### TECHNICAL FIELD

The present description relates generally to machine learning including, for example, human subject Gaussian splatting using machine learning.

### BACKGROUND

Machine-learning techniques have been applied to computer vision problems. Neural networks have been trained to capture the geometry and appearance of objects and scenes using large datasets with millions of videos and images.

### BRIEF DESCRIPTION OF THE DRAWINGS

Certain features of the subject technology are set forth in the appended claims. However, for purpose of explanation, several implementations of the subject technology are set forth in the following figures.

FIG. 1 illustrates an example system architecture including various electronic devices that may implement the subject system in accordance with one or more implementations of the subject technology.

FIG. 2 illustrates an example computing architecture for a system providing for human subject Gaussian splatting using machine learning in accordance with one or more implementations.

FIGS. 3A-3C illustrate triplane multi-layer perceptron network architectures of different decoder models in accordance with one or more implementations of the subject technology.

FIG. 4 illustrates an example electronic device providing human subject Gaussian splatting in accordance with one or more implementations of the subject technology.

FIG. 5 conceptually illustrates an example of a neural rendering framework in accordance with one or more implementations of the subject technology.

FIG. 6 illustrates a flow diagram of an example process for providing human subject Gaussian splatting in accordance with one or more implementations of the subject technology.

FIG. 7 illustrates a diagram of an example system process for human subject Gaussian splatting in accordance with one or more implementations of the subject technology.

FIG. 8 conceptually illustrates an example visualization of human subject pose renderings in canonical shape under different configurations of the neural rendering framework in accordance with one or more implementations of the subject technology.

FIG. 9 illustrates example neural rendering using joint human subject and scene optimization and neural rendering using separate human subject and scene optimization in accordance with one or more implementations of the subject technology.

FIG. 10 illustrates example novel pose renderings of human subjects in accordance with one or more implementations of the subject technology.

FIG. 11 illustrates example images depicting animation of multiple human subjects in novel scenes in accordance with one or more implementations of the subject technology.

FIG. 12 illustrates an example computing device with which aspects of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form to avoid obscuring the concepts of the subject technology.

A physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

The photorealistic rendering and animation of human bodies constitute a myriad of applications in areas such as AR/VR, visual effects, visual try-on, and movie production. To create human avatars that excel in delivering the desired outcomes, the tools employed can facilitate straightforward data capture, streamlined computational processes, and the establishment of a photorealistic and animatable portrayal of the human subject.

Recent methods for the creation of three-dimensional (3D) avatars of human subjects from videos can be classified into two primary categories. The first category includes 3D parametric body models, which provide benefits such as efficient rasterization and adaptability to unobserved deformations. In one or more implementations, modeling individuals with clothing or intricate hairstyles within this approach may be limited, stemming from the inherent constraints of template meshes, including fixed topologies and surface-like geometries. The second category includes neural implicit representations for the modeling of 3D human avatars. These neural implicit representations excel at capturing intricate details, such as clothing, accessories, and hair, surpassing the capabilities of techniques reliant on parametric body models. Nonetheless, these neural implicit representations involve certain trade-offs, particularly in terms of training and rendering efficiency. The inefficiency stems from the necessity of querying a multitude of points along the camera ray to render a single pixel. Furthermore, the challenge of deforming neural implicit representations in a versatile manner often demands the use of an inefficient root-finding loop, which adversely impacts both the training and rendering processes.

To tackle these challenges, an avatar representation is introduced to address for improved efficiency and practicality in the context of 3D human avatar modeling. The subject technology provides for supplying a sole video with the objective being the 3D reconstruction of both the human model and the static scene model. The subject technology facilitates the generation of human pose renderings, all without the necessity for costly multi-camera configurations or manual annotations. The subject technology utilizes 3D Gaussians to depict the canonical geometry of the human subject and acquires the capability to deform 3D Gaussian representations of the human subject for animation. In particular, a set of 3D Gaussians is optimized to portray the human geometry within a canonical space. When it comes to animation, a forward deformation module is employed to convert these points in the canonical space into a deformed space. This transformation leverages learned pose blend shapes and skinning weights, guided by pose parameters from a pre-trained parametric body model. The subject technology provides for enhancing the representation and animation of avatars.

In contrast to implicit representations, embodiments of the subject technology based on 3D Gaussians permit efficient rendering through a differentiable rasterizer. Furthermore, these 3D Gaussians can be effectively deformed utilizing certain techniques, such as linear blend skinning. When compared to meshes, 3D Gaussians offer greater flexibility and versatility. Unlike point clouds, 3D Gaussians may not give rise to gaps in the final rendered images. Moreover, beyond their capability to adapt to changes in topology for modeling accessories and clothing, 3D Gaussians prove well-suited for representing intricate volumetric structures, including hair. Prior approaches for view synthesis that jointly consider both the human subject and the scene rely on neural radiance fields (NeRF) as their representation. NeRF-based representations may face challenges related to ray warping and ray classification to correctly distinguish between scene and human points. In contrast, the utilization of 3D Gaussians can avoid this issue by jointly rasterizing the 3D Gaussians for both the scene and the human, while adhering to their respective depths. This leads to a notably more precise separation of the scene and human components compared to prior approaches. The subject technology also provides for enhancing the rendering and scene-human separation.

Embodiments of the subject technology provide for human subject Gaussian splatting using machine learning. A method includes receiving a video input having a scene and a subject. The method also includes obtaining a three-dimensional (3D) reconstruction of the subject and the scene from the video input. The method includes generating a 3D Gaussian representation of each of the scene and the subject. The method also includes generating a deformed 3D Gaussian representation of the subject by adapting the 3D Gaussian representation of the subject to the 3D reconstruction of the subject. The method includes rendering a visual output that includes at least one of an animatable avatar of the subject or the scene using differentiable Gaussian rasterization based at least in part on the deformed 3D Gaussian representation of the subject and the 3D Gaussian representation of the scene.

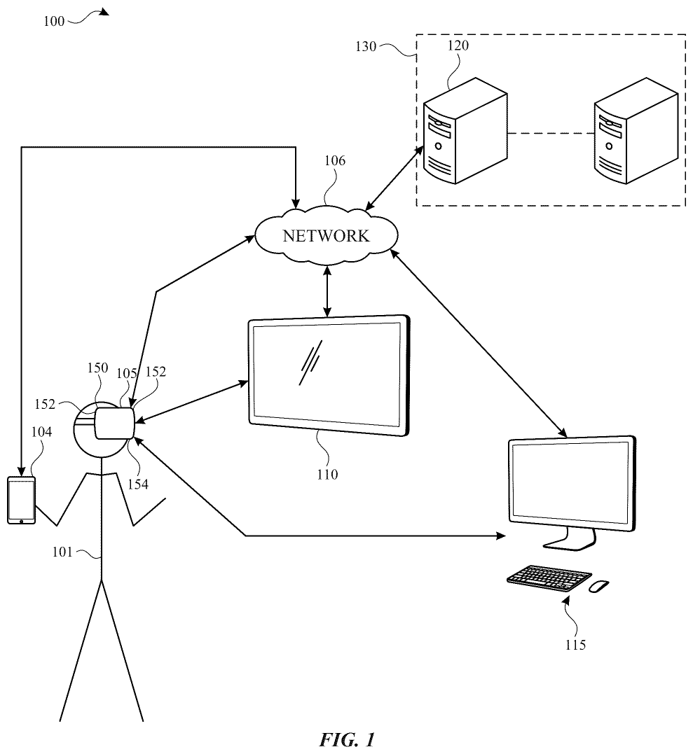

These and other embodiments are discussed below with reference to FIGS. 1-6. However, those skilled in the art will readily appreciate that the detailed description given herein with respect to these Figures is for explanatory purposes only and should not be construed as limiting.

FIG. 1 illustrates an example system architecture 100 including various electronic devices that may implement the subject system in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The system architecture 100 includes an electronic device 105, a handheld electronic device 104, an electronic device 110, an electronic device 115, and a server 120. For explanatory purposes, the system architecture 100 is illustrated in FIG. 1 as including the electronic device 105, the handheld electronic device 104, the electronic device 110, the electronic device 115, and the server 120; however, the system architecture 100 may include any number of electronic devices, and any number of servers or a data center including multiple servers.

The electronic device 105 is illustrated in FIG. 1 is a head-mounted portable system (e.g., worn by a user 101); however, the electronic device 105 may also be implemented, for example, as a tablet device, a handheld and/or mobile device. The electronic device 105 includes a display system capable of presenting a visualization of a computer-generated reality environment to the user. The electronic device 105 may be powered with a battery and/or another power supply. In an example, the display system of the electronic device 105 provides a stereoscopic presentation of the computer-generated reality environment, enabling a three-dimensional visual display of a rendering of a particular scene, to the user. In one or more implementations, instead of, or in addition to, utilizing the electronic device 105 to access a computer-generated reality environment, the user may use a handheld electronic device 104, such as a mobile device, tablet, watch, and the like.

The electronic device 105 may include one or more cameras such as camera(s) 150 (e.g., visible light cameras, infrared cameras, etc.). Further, the electronic device 105 may include various sensors 152 including, but not limited to, cameras, image sensors, touch sensors, microphones, inertial measurement units (IMU), heart rate sensors, temperature sensors, depth sensors (e.g., Lidar sensors, radar sensors, sonar sensors, time-of-flight sensors, etc.), GPS sensors, Wi-Fi sensors, near-field communications sensors, radio frequency sensors, etc. Moreover, the electronic device 105 may include hardware elements that can receive user input such as hardware buttons or switches. User input detected by such sensors and/or hardware elements correspond to, for example, various input modalities for performing one or more actions, such as initiating video capture of physical and/or virtual content. For example, such input modalities may include, but are not limited to, facial tracking, eye tracking (e.g., gaze direction), hand tracking, gesture tracking, biometric readings (e.g., heart rate, pulse, pupil dilation, breath, temperature, electroencephalogram, olfactory), recognizing speech or audio (e.g., particular hotwords), and activating buttons or switches, etc.

In one or more implementations, the electronic device 105 may be communicatively coupled to a base device the electronic device 115. Such a base device may, in general, include more computing resources and/or available power in comparison with the electronic device 105. In an example, the electronic device 105 may operate in various modes. For instance, the electronic device 105 can operate in a standalone mode independent of any base device. When the electronic device 105 operates in the standalone mode, the number of input modalities may be constrained by power and/or processing limitations of the electronic device 105 such as available battery power of the device. In response to power limitations, the electronic device 105 may deactivate certain sensors within the device itself to preserve battery power and/or to free processing resources.

The electronic device 105 may also operate in a wireless tethered mode (e.g., connected via a wireless connection with a base device), working in conjunction with a given base device. The electronic device 105 may also work in a connected mode where the electronic device 105 is physically connected to a base device (e.g., via a cable or some other physical connector) and may utilize power resources provided by the base device (e.g., where the base device is charging the electronic device 105 while physically connected).

In one or more implementations, when the electronic device 105 operates in the wireless tethered mode or the connected mode, a least a portion of processing user inputs and/or rendering the computer-generated reality environment may be offloaded to the base device thereby reducing processing burdens on the electronic device 105. For instance, in an implementation, the electronic device 105 works in conjunction with the electronic device 115 to generate a computer-generated reality environment including physical and/or virtual objects that enables different forms of interaction (e.g., visual, auditory, and/or physical or tactile interaction) between the user and the generated computer-generated reality environment in a real-time manner. In an example, the electronic device 105 provides a rendering of a scene corresponding to the computer-generated reality environment that can be perceived by the user and interacted with in a real-time manner. Additionally, as part of presenting the rendered scene, the electronic device 105 may provide sound, and/or haptic or tactile feedback to the user. The content of a given rendered scene may be dependent on available processing capability, network availability and capacity, available battery power, and current system workload.

The network 106 may communicatively (directly or indirectly) couple, for example, the electronic device 104, the electronic device 105, the electronic device 110, and/or the electronic device 115 with each other device and/or the server 120. In one or more implementations, the network 106 may be an interconnected network of devices that may include, or may be communicatively coupled to, the Internet.

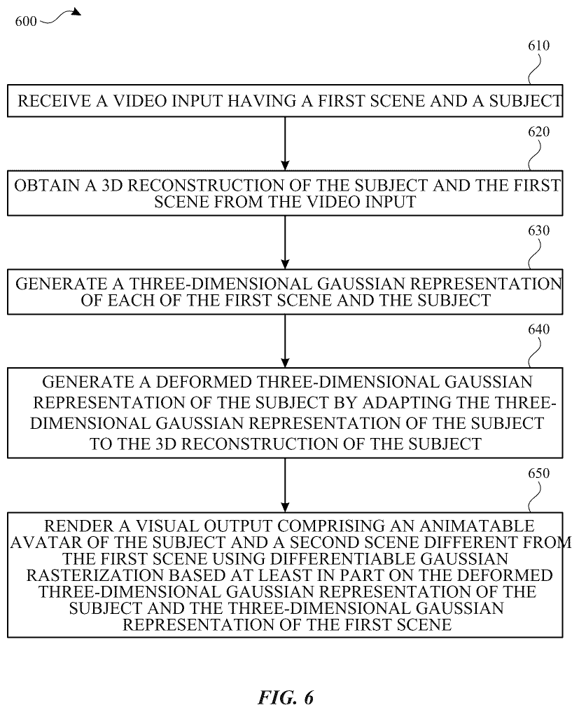

In FIG. 1, by way of example, the electronic device 110 is depicted as a television. The electronic device 110 may include a touchscreen and may be, for example, a television that includes a touchscreen, a smartphone that includes a touchscreen, a portable computing device such as a laptop computer that includes a touchscreen, a companion device that includes a touchscreen (e.g., a digital camera, headphones), a tablet device that includes a touchscreen, a wearable device that includes a touchscreen such as a watch, a band, and the like, any other appropriate device that includes, for example, a touchscreen, or any electronic device with a touchpad. In one or more implementations, the electronic device 110 may not include a touchscreen but may support touchscreen-like gestures, such as in a computer-generated reality environment. In one or more implementations, the electronic device 110 may include a touchpad. In one or more implementations, the electronic device 110, the handheld electronic device 104, and/or the electronic device 105 may be, and/or may include all or part of, the electronic device discussed below with respect to the electronic system discussed below with respect to FIG. 6. In one or more implementations, the electronic device 110 may be another device such as an Internet Protocol (IP) camera, a tablet, or a companion device such as an electronic stylus, etc.

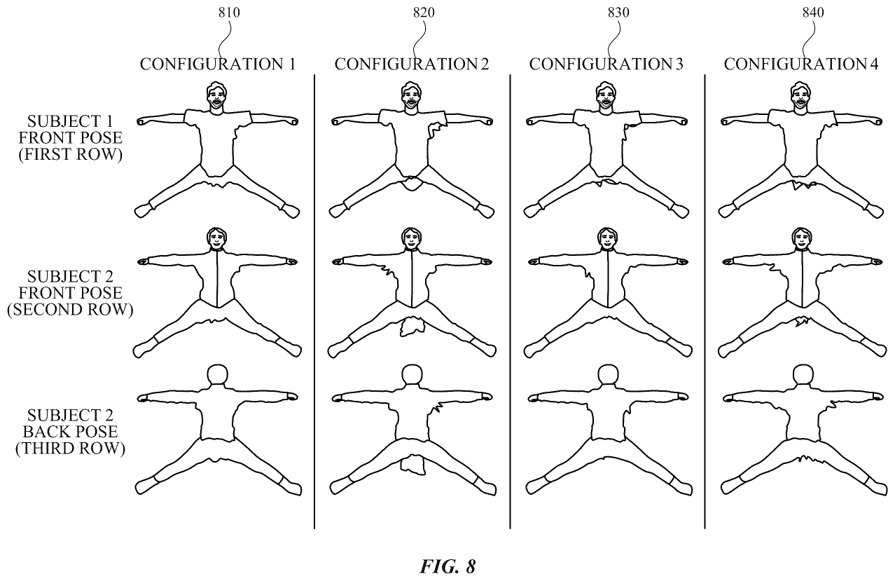

The electronic device 115 may be, for example, desktop computer, a portable computing device such as a laptop computer, a smartphone, a companion device (e.g., a digital camera, headphones), a tablet device, a wearable device such as a watch, a band, and the like. In FIG. 1, by way of example, the electronic device 115 is depicted as a desktop computer. The electronic device 115 may be, and/or may include all or part of, the electronic system discussed below with respect to FIG. 8.

The server 120 may form all or part of a network of computers or a group of servers 130, such as in a cloud computing or data center implementation. For example, the server 120 stores data and software, and includes specific hardware (e.g., processors, graphics processors and other specialized or custom processors) for rendering and generating content such as graphics, images, video, audio and multi-media files for computer-generated reality environments. In an implementation, the server 120 may function as a cloud storage server that stores any of the aforementioned computer-generated reality content generated by the above-discussed devices and/or the server 120.

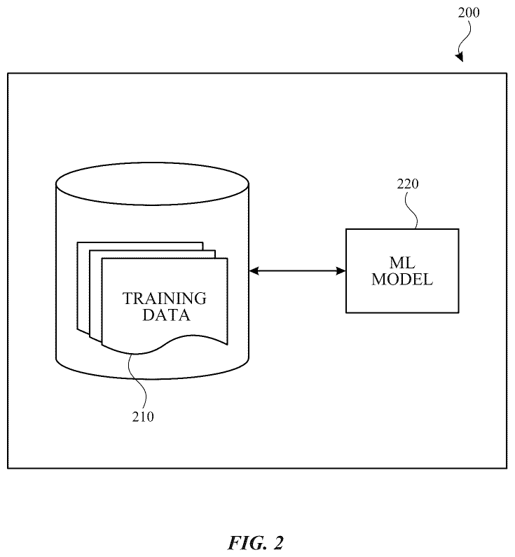

FIG. 2 illustrates an example computing architecture for a system providing for human subject Gaussian splatting using machine learning in accordance with one or more implementations. For explanatory purposes, the computing architecture is described as being provided by an electronic device 200, such as by a processor and/or memory of the server 120, or by a processor and/or a memory of any other electronic device, such as the electronic device 105. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

As illustrated, the electronic device 200 includes training data 210 for training a machine learning model. In an example, the server 120 may utilize one or more machine learning algorithms that uses training data 210 for training a machine learning (ML) model 220. Machine learning model 220 may include one or more neural networks.

Machine learning techniques have significantly advanced the field of neural rendering, enabling the creation of highly realistic and immersive digital content. Neural rendering techniques utilize deep learning models to bridge the gap between two-dimensional (2D) images and complex 3D scenes, allowing for the generation of novel viewpoints, realistic lighting, and even the insertion of virtual objects into real-world scenes. The ML model 220 can be trained on large datasets of images and corresponding 3D scene information. The ML model 220 can learn to understand the relationships between scene geometry, object appearances, lighting conditions, and camera viewpoints. One of the techniques is NeRF, which represents a scene as a continuous function and predicts the color and opacity of each point in space. This technique allows for the synthesis of novel views by interpolating between the observed images. The ML model 220 may include deep learning models, such as convolutional neural networks (CNNs) and recurrent neural networks (RNNs), which may be used to capture complex patterns in images and enable the synthesis of high-quality renderings.

In recent times, substantial improvements in the efficiency of neural rendering techniques have been observed, resulting in significantly reduced training and rendering times, often by several orders of magnitude. NeRF technology has played a predominant role in the progress of achieving photorealistic view synthesis. Traditional NeRF approaches involve the utilization of an implicit neural network for scene encoding, which has led to extended training durations. Various methods have been introduced to accelerate the training and rendering of NeRFs. These techniques have demonstrated notable performance in terms of both quality and speed. These methods encompass the adoption of explicit representations, such as function learning at grid points, optimization of low-level kernels, and the complete removal of the learnable component. However, their design predominantly focuses on the photogrammetric rendering of stationary scenes, which imposes limitations on their ability to effectively extend to the representation of mobile human subjects within the environment.

While NeRF technology has been recognized as a state-of-the-art technique for representing static 3D scenes, the extension of their application to dynamic scenes, particularly those involving human subjects, has posed certain difficulties. Traditional approaches to representing the human body have primarily emphasized geometric aspects. Early endeavors involved the acquisition of mesh representations for humans and their clothing, while subsequent developments embraced an implicit representation through the use of an occupancy field.

This issue is inherently associated with the challenge of structure-from-motion, in which the movements of the camera and the objects in the scene become entangled. Some approaches have addressed this challenge by using a multi-camera configuration within a controlled capture environment to separate the motion of the camera from the motion of human subjects. Another approach addressed this challenge by using a NeRF representation of a human subject using a single monocular video, enabling the generation of a 360-degree view of a human subject. Furthermore, another approach addressed this challenge by using a joint NeRF representation encompassing both the human subject and the scene, offering the capacity for view synthesis and human animation within the scene.

Embodiments of the subject technology provide for the use of a human subject Gaussian splat field, which is a representation of a human subject in conjunction with the surrounding scene, employing a 3D Gaussian splatting (3DGS) model. The scene may be modeled using a 3DGS framework, whereas the human subject is portrayed within a canonical space through the utilization of 3D Gaussians, guided by a human shape model. Furthermore, to capture intricate details of the human body that extend beyond the shape model, supplementary offsets are incorporated into the 3D Gaussians.

The subject technology utilizes a forward deformation module employing 3D Gaussians to acquire knowledge of a canonical human Gaussian model. The subject technology also executes joint optimization of scene and human Gaussians to demonstrate the mutual advantages of this combined optimization by facilitating the synthesis of views featuring both the human and the scene, as well as pose synthesis of the human within the scene. Embodiments of the subject technology include performance metrics that surpass baseline techniques, such as neural human radiance field, mesh, point-based, and implicit representations, all while reducing training time by a factor of 10 through the integration of the 3DGS model.

Embodiments of the subject technology in the present disclosure provide for enhancing the representation and animation of avatars and enhancing the rendering and scene-human separation. A method includes receiving a video input having a scene and a subject. The method also includes obtaining a three-dimensional (3D) reconstruction of the subject and the scene from the video input. The method includes generating a 3D Gaussian representation of each of the scene and the subject. The method also includes generating a deformed 3D Gaussian representation of the subject by adapting the 3D Gaussian representation of the subject to the 3D reconstruction of the subject. The method includes rendering a visual output that includes at least one of an animatable avatar of the subject or the scene using differentiable Gaussian rasterization based at least in part on the deformed 3D Gaussian representation of the subject and the 3D Gaussian representation of the scene.

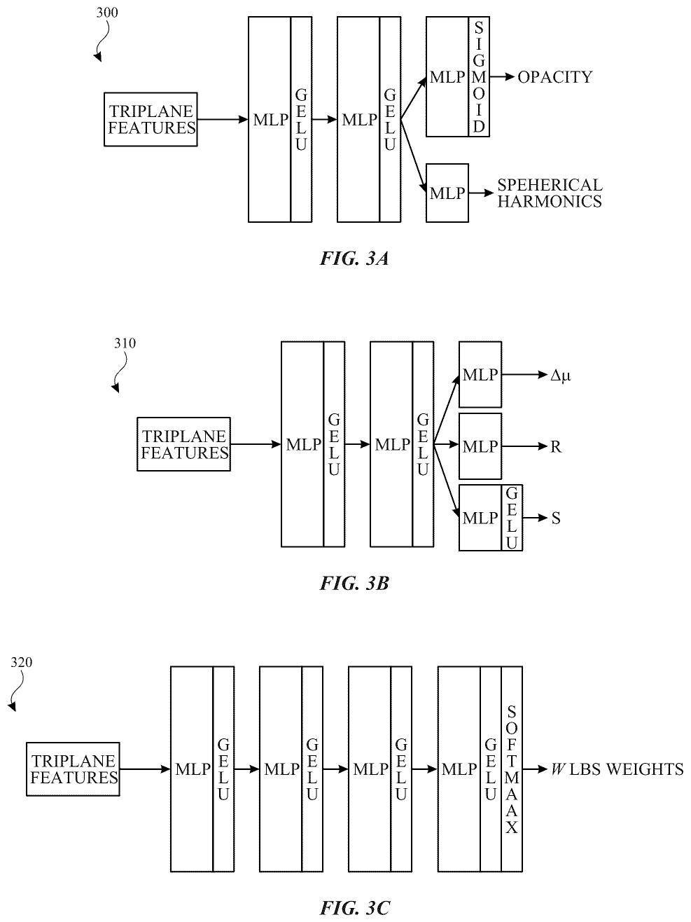

FIGS. 3A-3C illustrate triplane-multilayer perceptron (MLP) network architectures of different decoder models in accordance with one or more implementations of the subject technology. A detailed overview of the triplane-MLP model is provided in FIGS. 3A-3C, utilized for representing human avatars. The model employs lightweight MLP models to predict appearance, geometry, and deformation parameters of individual Gaussians. This enables efficient model training within a short timeframe without significantly increasing computational burden. In one or more implementations, the GELU activation function can promote quicker convergence. During rendering, both triplane and MLP models can be discarded once they predict the canonical human avatar and its deformation parameters. In one or more implementations, one or more of the illustrated triplane-MLP network architectures can facilitate fast rendering at 60 frames per second (FPS).

FIG. 3A illustrates a triplane-MLP network architecture 300 implemented as an appearance decoder (DA). The appearance decoder includes a 2-layer MLP with GELU activations, receiving triplane features as input to predict opacity and spherical harmonics parameters. Opacity values are bounded between 0 and 1 using a sigmoid activation function. While no activation function is applied to the spherical harmonics parameters, the resulting RGB values are bounded between 0 and 1 during rasterization.

FIG. 3B illustrates a triplane-MLP network architecture 310 implemented as a geometry decoder (DG). The geometry decoder employs a 2-layer MLP with GELU activation to generate Δμ, R, and S parameters for each Gaussian. The GELU activation facilitates that S is greater than or equal to 0. Notably, a normalization activation for R is not necessary as a 6D rotation representation is utilized.

FIG. 3C illustrates a triplane-MLP network architecture 320 implemented as a deformation decoder (DD). The deformation decoder utilizes a 3-layer MLP to produce linear blend skinning (LBS) weights. A low-temperature softmax activation function with T=0.1 is applied to facilitate that Σₖ₌₁ⁿ^{ₖ}W_{k,i}=1. The implementation of a low temperature aids in predicting unimodal distributions, as most Gaussians may require assignment to a single bone transformation.

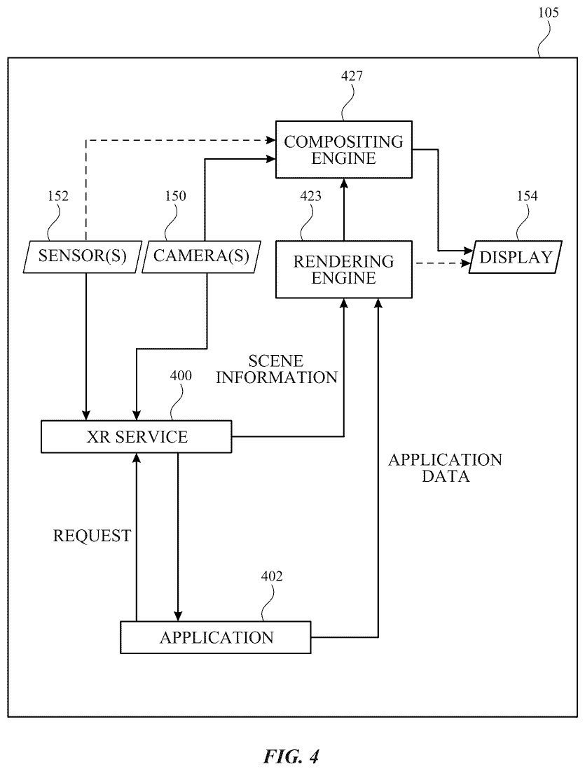

FIG. 4 illustrates how a system process of the electronic device 105 may provide human subject Gaussian splatting using machine learning. For example, FIG. 4 illustrates an example architecture that may be implemented by the electronic device 105 in accordance with one or more implementations of the subject technology. For explanatory purposes, portions of the architecture of FIG. 4 are described as being implemented by the electronic device 105 of FIG. 1, such as by a processor and/or memory of the electronic device; however, appropriate portions of the architecture may be implemented by any other electronic device, including the electronic device 110, electronic device 115, and/or server 120. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

Various portions of the architecture of FIG. 4 can be implemented in software or hardware, including by one or more processors and a memory device containing instructions, which when executed by the processor cause the processor to perform the operations described herein. For example, in FIG. 4, the trapezoidal boxes may indicate that the sensors 152, the camera(s) 150 and the display 154 may be hardware components, and the rectangular boxes may indicate that the XR service 400, the application 402, the rendering engine 423, and the compositing engine 427 may be implemented in software, including by one or more processors and a memory device containing instructions, which when executed by the processor cause the processor to perform the operations described herein.

In the example of FIG. 4, an application such as application 402 provides application data to a rendering engine 423 for rendering of the application data, such as for rendering of a UI of the application 402. Application 402 may be a gaming application, a media player application, a content-editor application, a training application, a simulator application, a social media application, or generally any application that provides a UI or other content for display at a location that depends on the physical environment, such as by anchoring the UI or other content to an anchor in the physical environment. The application data may include application-generated content (e.g., windows, buttons, tools, characters, images, videos, etc.) and/or user-generated content (e.g., text, images, etc.), and information for rendering the content in the UI. In one or more implementations, rendering engine 423 renders the UI of the application 402 for display by a display such as display 154 of the electronic device 105. In one or more implementations, the XR service 400 may assign a portion of a physical environment of the electronic device to the application 402.

As shown in FIG. 4, additional information may be provided for display of the UI of the application 402, such as in a two-dimensional or three-dimensional (e.g., XR) scene. In the example of FIG. 4, sensors 152 may provide physical environment information (e.g., depth information from one or more depth sensors, motion information from one or more motion sensors), and/or user information to an XR service 400. Camera(s) 150 may also provide images of a physical environment and/or one or more portions of the user (e.g., the user's eyes, hands, face, etc.) to XR service 400. XR service 400 may generate scene information, such as three-dimensional map, of some or all of the physical environment of electronic device 105 using the environment information (e.g., the depth information and/or the images) from sensors 152 and camera(s) 150. The XR service 400 may also determine a gaze location based on images and/or other sensor data representing the position and/or orientation of the user's eye(s). The XR service 400 may also identify a gesture (e.g., a hand gesture) performed by a user of the electronic device 105, based on images and/or other sensor data representing the position and/or orientation of the user's hand(s) and/or arm(s).

As illustrated in FIG. 4, in one or more implementations, the application 402 may provide a request to the XR service 400. For example, the request may be a request for scene information (e.g., information describing the content of the physical environment), and/or a request for user information such as a request for a gaze location and/or user gesture information. In one example, the request may be an anchor request for a physical anchor (e.g., a horizontal surface, a vertical surface, a floor, a table, a wall, etc.).

Application 402 may include code that, when executed by one or more processors of electronic device 105, generates application data, for display of the UI of the application 402 on, near, attached to, or otherwise associated with an anchor location corresponding to the anchor identified by the identifier provided from XR service 400. Application 402 may include code that, when executed by one or more processors of electronic device 105, modifies and/or updates the application data based on user information (e.g., a gaze location and/or a gesture input) provided by the XR service 400.

Once the application data has been generated, the application data can be provided to the XR service 400 and/or the rendering engine 423, as illustrated in FIG. 4. As shown, scene information can also be provided to rendering engine 423. The scene information provided from the XR service 400 to the rendering engine 423 can include or be based on, as examples, environment information such as a depth map of the physical environment, and/or object information for detected objects in the physical environment. Rendering engine 423 can then render the application data from application 402 for display by display 154 of electronic device 105 to appear at a desired location in a physical environment. Display 154 may be, for example, an opaque display, and camera(s) 150 may be configured to provide a pass-through video feed to the opaque display. The UI of the application 402 may be rendered for display at a location on the display corresponding to the displayed location of a physical anchor object in the pass-through video. Display 154 may be, as another example, a transparent or translucent display. The UI of the application 402 may be rendered for display at a location on the display corresponding to a direct view, through the transparent or translucent display, of the physical environment.

As shown, in one or more implementations, electronic device 105 can also include a compositing engine 427 that composites video images of the physical environment, based on images from camera(s) 150, for display together with the UI of the application 402 from rendering engine 423. For example, compositing engine 427 may be provided in an electronic device 105 that includes an opaque display, to provide pass-through video to the display. In an electronic device 105 that is implemented with a transparent or translucent display that allows the user to directly view the physical environment, compositing engine 427 may be omitted or unused in some circumstances or may be incorporated in rendering engine 423. Although the example of FIG. 4 illustrates a rendering engine 423 that is separate from XR service 400, it should be appreciated that XR service 400 and rendering engine 423 may form a common service and/or that rendering operations for rendering content for display can be performed by the XR service 400. Although the example of FIG. 4 illustrates a rendering engine 423 that is separate from application 402, it should be appreciated that, in some implementations, application 402 may render content for display by display 154 without using a separate rendering engine. Although a single instance of the application 402 is depicted in FIG. 4, it is appreciated that multiple applications may be running concurrently on the electronic device 105, generating application data for rendering of respective UIs for display by display 154. In one or more implementations, compositing engine 427 may composite application data for multiple UIs of multiple applications for concurrent display.

In one or more implementations, the rendering engine 423 includes a machine learning model (e.g., the ML model 220), the ML model 220 being trained to recognize and process visual content for improved rendering quality. The electronic device 105 can capture one or more frames of visual content for rendering on the display 154, and the frames of visual content are input into the ML model 220. The ML model 220 can employ its learned parameters to analyze the input frames, and it generates modified rendering instructions based on its analysis. The modified rendering instructions may be subsequently used by the rendering engine 423 to adjust the rendering of visual content on the display 154, thereby enhancing rendering quality and providing an improved visual experience for users of the electronic device 105. The ML model 220 can be trained on a dataset having diverse visual content and rendering scenarios, enabling it to adapt to a wide range of rendering tasks and achieve superior rendering performance.

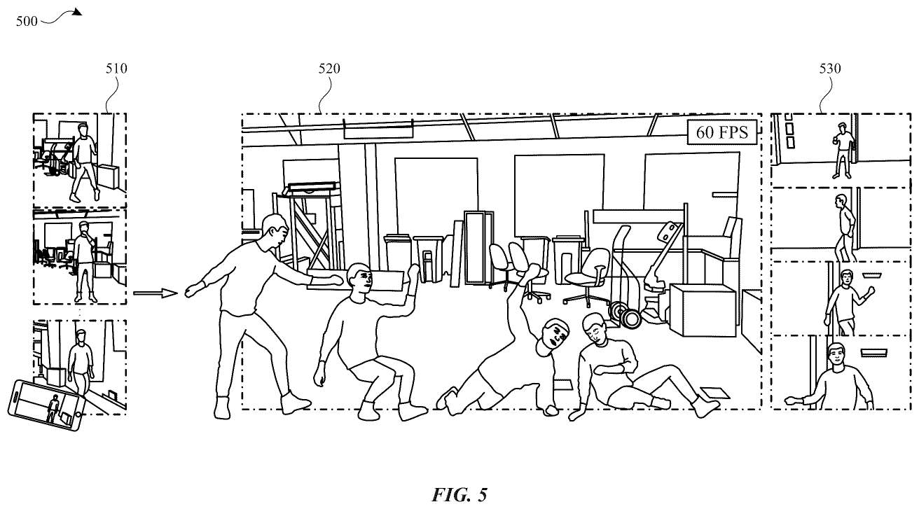

FIG. 5 conceptually illustrates an example of a neural rendering framework 500 in accordance with one or more implementations of the subject technology. In order to facilitate human-body deformation, embodiments of the subject technology provide for the neural rendering framework 500 to employ a deformation model that represents the human body in a canonical space using 3D Gaussians. In one or more implementations, this deformation model predicts mean-shifts, rotations, and scale adjustments of the 3D Gaussians to conform to the body shape of a human subject in the canonical pose. Additionally, the deformation model can predict LBS weights used to deform the canonical human into a final pose. The initialization of the neural rendering framework 500 can be based on a parametric body shape model, with allowance for deviations, increases, and pruning from the body model by the Gaussians. This flexibility can allow the neural rendering framework 500 to capture geometry and appearance details, such as hair and clothing, beyond the body model. The learned LBS weights also coordinate Gaussian movement during animation. In one or more implementations, the neural rendering framework 500, using the ML model 220, is trained using a single monocular video consisting of 50-100 frames, learning a disentangled representation of the human subject and scene for versatile use of the avatars in different scenes (e.g., 530).

In one or more implementations, the neural rendering framework 500 is a neural representation for a human subject within a scene, facilitating novel pose synthesis of the human subject and novel view synthesis of both the human subject and the scene. A forward deformation module can represent a target human subject in a canonical space using 3D Gaussians and learn to animate them using LBS to unobserved poses. In one or more implementations, the neural rendering framework 500 facilitates the creation and rendering of animatable human subject avatars from in-the-wild monocular videos via input frames 510 containing a small number of frames (e.g., 50-100). In one or more implementations, the neural rendering framework 500 can render images at about 60 FPS (e.g., 520) at high-definition (HD) resolution or at least achieve state-of-the-art reconstruction quality compared to baselines.

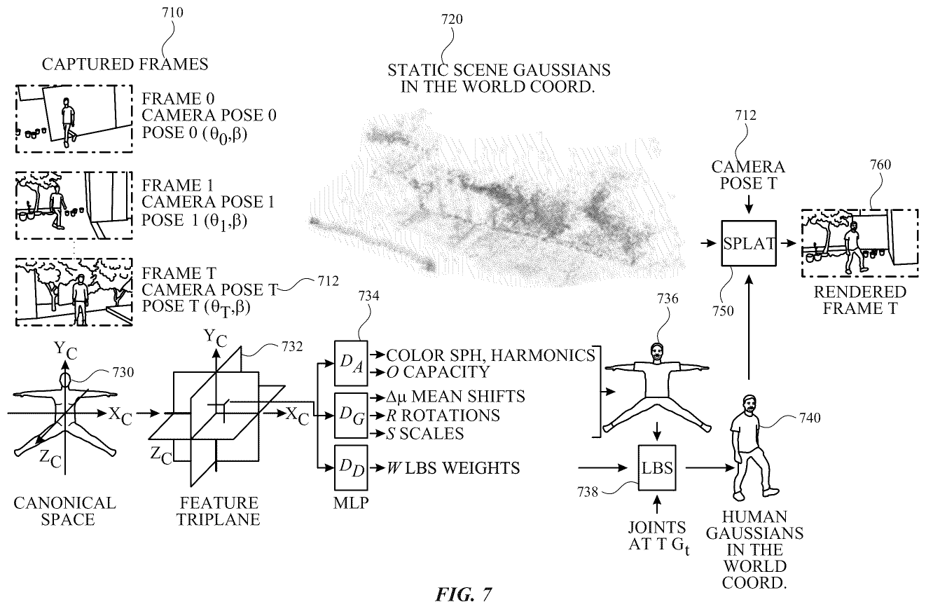

FIG. 6 illustrates a flow diagram of an example process 600 for providing human subject Gaussian splatting in accordance with implementations of the subject technology. For explanatory purposes, the process 600 is primarily described herein with reference to the rendering engine 423 (of the electronic device 105) of FIG. 4. However, the process 600 is not limited to the electronic device 105 of FIG. 1, and one or more blocks (or operations) of the process 600 may be performed by one or more other components of other suitable devices, including the electronic device 104, the electronic device 110, and/or the electronic device 115. For explanatory purposes and illustration, some or all of the blocks of the process 600 are described herein with reference to aspects of FIG. 7, which illustrates a diagram of an example process for human subject Gaussian splatting in accordance with one or more implementations of the subject technology. Further for explanatory purposes, some of the blocks of the process 600 are described herein as occurring in serial, or linearly. However, multiple blocks of the process 600 may occur in parallel. In addition, the blocks of the process 600 need not be performed in the order shown and/or one or more blocks of the process 600 need not be performed and/or can be replaced by other operations.

As illustrated in FIG. 6, at block 610, the rendering engine 423 receives a video input having a scene and a subject. With reference to FIG. 7, at 710, the rendering engine 423 starts with the video input that contains dynamic motion of a human subject and camera motions. This video input may serve as the source of data for the view synthesis process.

At 620, the rendering engine 423 may obtain a 3D reconstruction of the subject and the scene from the video input. The rendering engine 423 can estimate human pose parameters and body shape parameters from the captured images (or frames) and their corresponding camera poses. In one or more implementations, the rendering engine 423 can utilize a pretrained regressor to estimate the pose parameters for each image and a shared body shape parameter. In some aspects, this step involves extracting scene point-cloud data, camera parameters (including camera motion), and body model parameters θ, which represent the pose and shape of the human subject. In some examples, a first frame (denoted as frame 0) can include camera pose 0 and pose 0 (θ₀, η), a first frame (denoted as frame 1) can include camera pose 1 and pose 1 (θ₁, η), and a subsequent frame (denoted as frame t) can include camera pose t (e.g., 712) and pose t (θ₁, η).

Human Gaussians are constructed using center locations in a canonical space (e.g., 730), along with a feature triplane 732 (F∈ [symbol] ^{3×h×w×d}), and three MLPs, as described with reference to FIGS. 3A-3C, to predict Gaussian properties. Optimization is performed individually for each person. These Gaussians exist in a canonical space where the human mesh performs a predefined Da-pose. The human representation can be modeled using 3D Gaussians, driven by a learned LBS technique. The output includes Gaussian locations, rotations, scales, spherical harmonics coefficients, and their associated LBS weights with respect to the joints. For example, with reference to FIG. 7 at 734, the three MLPs are used to estimate their color, opacity, additional shift, rotation, scale, and LBS weights to animate the Gaussians with given joint configurations.

With reference to FIG. 7, at 720, the rendering engine 423 may apply a structure-from-motion (SfM) operation as part of the 3D reconstruction to recover the 3D structure of the scene from a set of 2D video frames in the video input taken from different viewpoints. The SfM operation attempts to reconstruct the spatial positions of points or features in the scene and the camera poses (positions and orientations) from which these 2D video frames were captured. In one or more implementations, the SfM operation may first identify and match features in the 2D video frames. These features can be distinctive points like corners, edges, or other salient parts of the scene. In one or more implementations, the SfM operation may create a sparse 3D point cloud by triangulating the matched 2D features from multiple video frames. In one or more implementations, the SfM operation may estimate the camera poses by determining where each 2D video frame was taken relative to the reconstructed 3D points. The SfM operation may proceed incrementally, adding more 2D video frames from the video input and points to the 3D reconstruction as new video frames are considered. In one or more implementations, after an initial reconstruction, the SfM operation includes a global bundle adjustment, optimizing the camera poses and the 3D point positions to minimize reprojection errors and refine the accuracy of the 3D model.

In one or more implementations, as part of the 3D reconstruction at 620 and with reference to FIG. 7, at 710, the rendering engine 423 performs a pose estimation of the subject using a 3D human body model. In one or more implementations, the rendering engine 423 employs a body model, which represents a statistical linear model of human body shape and pose. For example, at 710, the rendering engine 423 can extract the body model parameters represented as θ, which represent the pose and shape of the human subject.

The parametric body model can capture the variability in body shape and describe how joints of the human body can move by fitting the body model to the 2D observations. In some aspects, the parametric body model can encode variations in body shape and pose using linear combinations of a set of basis shapes and poses. In some aspects, the parametric body model uses a skinned mesh representation with associated deformation weights. For example, the mesh vertices are deformed according to the body shape and pose, allowing the generation of a detailed 3D model of a human body.

In one or more implementations, the rendering engine 423 may perform the SfM operation simultaneously with performing the pose estimation of the subject. In one or more implementations, the rendering engine 423 may utilize a regressor to obtain pose parameters represented as θ and shape parameters represented as β for each 2D video frame within the video input. In one or more other implementations, the rendering engine 423 may perform a subsequent refinement step to optimize the pose and shape parameters using 2D joint information, improving the alignment of the body model estimates within the scene coordinates.

In one or more implementations, the parametric body model allows for control over pose and shape. The template mesh of a human subject (T̅, F) in the rest pose (e.g., T-pose) in the template coordinate space. In one or more implementations, T̅ϵ [symbol] ⁿ^{ₚ}^{×3} represents the nₜ vertices on the template mesh for body shape in the rest pose, and Fϵ [symbol] ⁿ^{ₜ}^{×3} represents the nₜ triangles with a fixed topology. Given the body shape parameters, βϵ [symbol] ^{|β|}, and the pose parameters, θϵ [symbol] ³ⁿ^{ₖ}⁺³, the body model can transform the vertices T̅ from the template coordinate space to the shaped space, which can be defined as:

$${T}_{S} ( β , θ ) = \overline{T} + {B}_{S} ( β ) + {B}_{P} ( θ ) , \qquad ( 1 )$$

Where T_{S}(β, θ) are the vertex locations in the shaped space, B_{S}(β)ϵ [symbol] ⁿ^{ₚ}^{×3} and B_{S}(θ)ϵ [symbol] ⁿ^{ₚ}^{×3} are the xyz offsets to individual vertices. The mesh in the shaped space fits the identity (e.g., body type) of the human shape in the rest pose. To animate the human mesh to a certain pose (i.e., transforming the mesh to the posed space), a body model can utilize nₖ predefined joints and LBS. The LBS weights Wϵ [symbol] ⁿ^{ₖ}^{×n}^{ᵥ} are provided by a body model. Given the i-th vertex location on the resting human mesh, pᵢϵ [symbol] ³, and individual posed joints' configuration (e.g., their rotation and translation in the world coordinate), G=[G₁ . . . . Gₙ_{ₖ}], where GₖϵSE(3), the posed vertex location vᵢ is calculated as vᵢ=(Σₖ₌₁ⁿ^{ₖ}W_{k,i}Gₖ)pᵢ, where W_{k,i}ϵ [symbol] is the element in W corresponding to the k-th joining and the i-th vertex. In one or more other implementations, βϵ [symbol] ^{|B|∈R|β| signifies the body identity parameters, and the function B}_{S}(β): [symbol] ^{|β|}→ [symbol] ⁿ^{ₚ}^{λ3} defines the identity blend shapes. Specifically, B_{S}(β)=Σᵢ₌₁^{|β|}βᵢSᵢ, where βᵢ is the i-th linear coefficient, and Sᵢ is the i-th orthonormal principal component. The parameter θϵ [symbol] ³ⁿ^{ₖ}⁺³ denotes the pose parameters. Similar to the shape space S, B_{P}(θ): [symbol] ^{|θ|}→ [symbol] ⁿ^{ₚ}^{×3} represents the pose blend shapes, with P being the pose space from the parametric body model. To capture finer geometric details, an up-sampled version of the body model is utilized, featuring nᵥ at about 110,210 vertices and nₜ at about 220,416 faces. In one or more implementations, the values for nᵥ and nₜ can vary without departing from the scope of the present disclosure.

In one or more implementations, the SfM and pose estimation operations involve the use of trained machine learning models (e.g., ML model 220) for 3D reconstruction. For example, pose estimation models can be trained on large datasets that provide images with annotated joint positions and use deep learning techniques to predict the pose of the human subject in the 2D video frames.

At 630, the rendering engine 423 may generate a three-dimensional Gaussian representation of the subject. This step can involve representing the human subject using 3D Gaussian representations. In one or more implementations, this Gaussian representation of the human subject can be placed in canonical coordinates (or positions in a canonical space) and serve as the basis for further downstream processing. With reference to FIG. 7, at 730, the human subject (T) is represented in a canonical shape using 3D Gaussians in canonical coordinates.

In one or more implementations, Gaussians are initiated from the body model template and the geometry, appearance, and deformation are learned over this template's Gaussians. In one or more implementations, the Gaussian means is initialized directly from the body model vertices. In this regard, the 3D Gaussian representation of the human subject is initiated by obtaining vertices from the parametric body model and subdividing the vertices by a factor of 2. For example, the human subject representation in canonical space employs the body model template T̅, which is subdivided into 110, 210 vertices. Each vertex may be associated with a 3D Gaussian. The Gaussian means μᵢ is initialized from the body model vertices directly. Gaussian rotations Rᵢ is initialized using the body model vertex normals. In some aspects, initial rotations for the Gaussians may be set to identity matrices. For the scale Sᵢ initialization, the mean edge length ledge for a given mesh vertex is computed, and Sᵢ is set to [l_{edge}, l_{edge}, 10⁻⁴]. For scale initialization, the rendering engine 423 may employ the equation x=x+1. The opacity σᵢ is initialized as 0.1.

In one or more implementations, the 3D Gaussians are initialized using a human body template mesh containing nᵥ=110, 210 vertices. In one or more other implementations, the uniform subdivision across the body can lead to certain areas (e.g., face, hair, clothing) lacking sufficient points to represent high-frequency details. In this regard, the number of 3D Gaussians can be adaptively controlled during optimization. The densification process commences after training the model for an arbitrary number of iterations (e.g., 3000 iterations), with additional densification steps occurring at a periodic number of iterations (e.g., every 600 iterations).

To model personalized geometry, clothing, and deformation details, graph convolutional network (GCN)-based modules are employed, operating on the surface of the Gaussian mesh and the surface triangulation of the template mesh (μ, R, S, F). In one or more implementations, the ML model 220 includes three graph convolutional decoder networks: (1) a geometry decoder that models geometric offsets in canonical space as described with reference to FIG. 3B, (2) an appearance decoder as described with reference to FIG. 3A, and (3) a deformation decoder as described with reference to FIG. 3C. These decoder networks take learnable Gaussian embeddings G_{embed}∈ [symbol] ⁷² as input.

In one or more implementations, the geometry decoder network predicts deformations of the Gaussian mean (Δμ), rotations (ΔR), and scales (ΔS) in canonical space, as described with reference to FIG. 3B. In one or more implementations, the appearance network predicts the opacity (σᵢ) and the spherical harmonics coefficients, which are converted to cᵢ for each of the Gaussians, as described with reference to FIG. 3A. In one or more implementations, the deformation network estimates pose-correctives B_{P} and the weights (W) of the linear blend skinning function, as described with reference to FIG. 3C. The deformation of the Gaussians from canonical space to the observation is then given by:

$${T}_{G} = {\sum }_{k = 1}^{{n}_{k}} {W}_{k , i} {G}_{k} ( θ , J ( β ) ) , \qquad ( 2 )$$

$${μ}_{i}^{o} = {T}_{G} \cdot ( {μ}_{i} + {Δμ}_{i} ) , \qquad ( 3 )$$

$${R}_{i}^{o} = {T}_{G} \cdot ( {R}_{i} \cdot Δ {R}_{i} ) . \qquad ( 4 )$$

In Equation 2, TG is the global transformation matrix obtained by linearly blending the body model joint transformations. Here, the LBS weights W and pose-correctives B_{P} are estimated by deformation decoder D_{D}, where ·μᵢ^{o} and Rᵢ^{o} denote the deformed Gaussian parameters.

In one or more implementations, the 3D Gaussian representations are parameterized using mean μ, rotation R, and scale S. In one or more implementations, the appearance of these 3D Gaussian representations is depicted through spherical harmonics. Each Gaussian representation can be envisioned as softly representing a portion of 3D physical space containing solid matter. Every Gaussian representation may exert influence over a point in the physical 3D space (p) through the application of the standard (unnormalized) Gaussian equation. The influence of a Gaussian to a point p∈R³ by evaluating the probability density function defined as:

$$G ( p ) = σ ( {o}_{i} ) {e}^{- \frac{1}{2} {( p - {μ}_{i} )}^{T} {\sum }_{i}^{- 1} ( p - {μ}_{i} )} . \qquad ( 5 )$$

In this equation, p∈ [symbol] ³ is a xyz location, oᵢ∈[0,1] is the opacity modeling the ratio of radiance the Gaussian absorbs, μᵢ∈ [symbol] ³ is the center/mean of the Gaussian, and the covariance matrix Σᵢ is parameterized by the scale Sᵢ∈ [symbol] ³ along each of the three Gaussian axes and the rotation Rᵢ∈SO(3) with Σᵢ=RᵢSᵢSᵢ^{T} Rᵢ^{T}. Each Gaussian can also be paired with spherical harmonics to model the radiance emit towards various directions.

In one or more implementations, oᵢ∈R is the opacity of each Gaussian and σ is the sigmoid function. Here, μᵢ=[xᵢ yᵢ zᵢ]^{T} represents the center of each Gaussian I, while Σᵢ=RᵢSᵢSᵢ^{T} Rᵢ^{T} denotes the covariance matrix of Gaussian i. This matrix is formed by combining the scaling component Sᵢ=diag ([sxᵢ syᵢ szᵢ]), and the rotation component Rᵢ=q2R ([qwᵢ qxᵢ qyᵢ qzᵢ]). Here, q2R( ) denotes the procedure for constructing a rotation matrix from a quaternion. The standard sigmoid function is represented as. In one or more implementations, each Gaussian is parametrized by the covariance matrix Σᵢ and a mean uᵢ∈R³. In one or more implementations, the covariance matrix Σᵢ is factorized into Rᵢ∈SO(3) and Sᵢ∈R³ where Σᵢ=RᵢSᵢSᵢ^{T} Rᵢ^{T}.

The influence function (ƒ) of each Gaussian may be both intrinsically local, allowing it to represent a limited spatial area, and theoretically extends infinitely, enabling gradients to propagate even from substantial distances. This long-distance gradient flow facilitates gradient-based tracking through differentiable rendering, as it guides Gaussian representations situated in an incorrect 3D position to adjust their location to the accurate 3D coordinates. The inherent softness of this Gaussian representation necessitates significant overlap among Gaussians to effectively represent a physically solid object. Beyond the spatial aspect, each Gaussian also contributes its unique appearance characteristics to every 3D point under its influence.

At 640, the rendering engine 423 may generate a deformed three-dimensional Gaussian representation of the subject by adapting the three-dimensional Gaussian representation of the subject to the 3D reconstruction of the subject. This step may involve utilizing a forward deformation module to facilitate the learning of personalized pose correctives, denoted as B_{P}(θ), and linear blend skinning weights, denoted as W. This step facilitates adapting the 3D Gaussian representations to the specific pose and shape of the human subject in the video input. In one or more other implementations, the 3D Gaussian representation of the subject may be generated by applying a trained machine learning model to adapt the 3D Gaussian representation of the subject to the 3D reconstruction of the subject.

With reference to FIG. 7, at 734, the rendering engine 423 employs a forward deformation module to facilitate the acquisition of personalized pose corrections denoted as B_{P}(θ). In one or more implementations, the forward deformation module utilizes machine learning for learning personalized pose correctives and linear blend skinning weights. This process may involve training a machine learning model (e.g., the ML model 220) to adapt the 3D Gaussian representations to the specific pose and shape of the human subject in the video input.

In the context of pose-dependent deformation, the objective is to model the movement of the human subject based on the provided video input (e.g., monocular video). The initialized avatar, which is based on the parametric body model (e.g., obtained at 736), serves as a means to capture pose deformation. For each frame in the given video, the rendering engine 423 can estimate the body model parameters denoted as θ∈R^{|θ|}. In one or more implementations, the rendering engine 423, via the forward deformation module, can apply deformation to the head and body of the initialized avatar to align them with the observed pose using a LBS function.

In one or more implementations, the deformation for the explicit mesh model is governed by a differential function M(β, θ, ψ, O) that generates a 3D human body mesh (V, F), where V∈ [symbol] ⁿ^{ₚ}^{×3} represents a collection of nᵥ vertices, and F∈ [symbol] ⁿ^{ₜ}^{×3} signifies a collection of nₜ faces, adhering to a fixed topology. This deformation function is expressed as follows:

$$M ( β , θ , ψ , O ) = LBS ( {\tilde{T}}_{P} ( β , θ , ψ , O ) , J ( β ) , θ , W ) . \qquad ( 6 )$$

Given a joint configuration G, an image is rendered by interpolating a triplane at the center location of each Gaussian to obtain feature vectors ƒₓⁱ, ƒ_{y}ⁱ, ƒ_{z}ⁱ∈ [symbol] ^{d}. These features are input into separate MLPs: an appearance MLP (DA) outputs RGB color and opacity, a geometry MLP (DG) outputs offset (Δμᵢ), rotation matrix (R), and scale parameters, and a deformation MLP (DD) outputs LBS weights, as described with reference to 734 of FIG. 7. The LBS weights and joint transformation G are used to transform the Human Gaussians, which are combined with Scene Gaussians (e.g., 720 of FIG. 7) and splatted onto the image plane (e.g., 750 of FIG. 7). In one or more implementations, the rendering process is end-to-end differentiable.

With reference to FIG. 7, at 738, the rendering engine 423 applies linear blend skinning weights, represented as W, to the deformation. Within this equation, W∈ [symbol] ⁿ^{ₖ}^{×n}^{ᵥ} denotes the blend skinning weights used in the LBS function, and J(β)∈ [symbol] ⁿ^{ₖ}^{×3} is a function dependent on body shape, representing the shape-dependent joints. The transformation of a template vertex tᵢ to the vertex vᵢ is achieved through a straightforward linear transformation. In one or more implementations, the forward vertex-wise deformation is represented as follows in homogeneous coordinates:

$${\underbrace{{v}_{i}}}_{Posed Vertex} = {\underbrace{{\sum }_{k = 1}^{{n}_{k}} {W}_{k , i} {G}_{k} ( θ , J ( β ) ) \cdot [ \begin{matrix}I & {o}_{i} + {b}_{i} \\ 0 & 1\end{matrix} ]}}_{{M}_{i} ( β , θ , ψ , O ) : Deformation to the posed space} \cdot {\underbrace{{t}_{i}}}_{Template Vertex} . \qquad ( 7 )$$

Here, Mᵢ(β, θ, ψ, O)∈ [symbol] ^{4×4} denotes the deformation function for the template vertex tᵢ. W_{k,i} represents the (k, i)-th element of the blend weight matrix W. The function Gₖ(θ, J(β))∈ [symbol] ^{4×4} represents the world transformation of the k-th joint, and bᵢ stands for the i-th vertex resulting from the sum of all blend shapes B:=B_{S}(β)+B_{P}(θ)+B_{E}(ψ). The vertex set of the posed avatar (vᵢ∈V) is denoted as V. In one or more implementations, both vᵢ and tᵢ are expressed in homogeneous coordinates when applying this deformation function.

At 650, the rendering engine 423 may render a visual output (e.g., 760 of FIG. 7) having at least one of an animatable avatar of the subject or the scene using differentiable Gaussian rasterization based at least in part on the deformed three-dimensional Gaussian representation of the subject and the three-dimensional Gaussian representation of the scene. This step involves projecting the Gaussian representations onto a 2D image plane from different viewpoints.

With reference to FIG. 7, at 750, the rendering engine 423 may perform view synthesis of the scene using the 3D structure of the scene from the SfM operation at 720. For example, the rendering engine 423 may render the 3D scene from a new viewpoint. In one or more other implementations, the rendering engine 423 may perform the view synthesis of the scene based at least in part on the 3D Gaussian representation of the scene.

With reference to FIG. 7, at 750, the rendering engine 423 renders the scene and deformed human 3D Gaussians through the utilization of differentiable Gaussian rasterization. The result of these steps is the synthesis of 2D images or views from different angles that include an animatable human avatar and the scene.

The operation at 750 represents differentiable rendering via Gaussian 3D splatting, which involves rendering the Gaussians into images in a differentiable manner to optimize their parameters for scene representation. The rendering at 750 may entail the splatting of 3D Gaussians onto the image plane, approximating the projection of the influence function ƒ along the depth dimension of the 3D Gaussian into a 2D Gaussian influence function in pixel coordinates.

The center of the Gaussian is projected into a 2D image using the standard point rendering formula:

$${μ}^{2 D} = K ( ( {E}_{μ} ) / {( {E}_{μ} )}_{z} ) . \qquad ( 8 )$$

In this equation, the 3D Gaussian center u is projected into a 2D image through multiplication with the world-to-camera extrinsic matrix E, z-normalization, and multiplication by the intrinsic projection matrix K. The 3D covariance matrix is projected into 2D as follows:

$${\sum }_{i}^{2 D} = JW {\sum }_{i} {W}^{T} {J}^{T} . \qquad ( 9 )$$

In one or more implementations, J represents the Jacobian of the affine approximation of the projective transformation and W is the viewing transformation. In one or more other implementations, J represents the Jacobian of the point projection formula, specifically ∂μ^{2D}/∂μ. The influence function ƒ can be assessed in 2D for each pixel of each Gaussian.

In one or more implementations, to obtain the final color for each pixel, the rendering engine 423 can sort and blend the N Gaussians contributing to a pixel using the volume rendering formula defined as:

$$C = {\sum }_{j ∈ N} {c}_{j} {α}_{j} {\prod }_{k = 1}^{j - 1} ( 1 - {α}_{k} ) . \qquad ( 10 )$$

In this equation, cⱼ is the color of each point obtained by evaluating the spherical harmonics given viewing transform W and αⱼ is given by evaluating the 2D Gaussian with the covariance 2j multiplied with σ opacity. In one or more implementations, the rendering process is differentiable.

In one or more other implementations, the cumulative influence of all Gaussians on a given pixel is calculated by sorting the Gaussians in depth order and performing front-to-back volume rendering using a volume rendering formula defined as:

$${C}_{pix} = {\sum }_{i ∈ S} {c}_{i} {f}_{i , pix}^{2 D} {\prod }_{j = 1}^{i - 1} ( 1 - {f}_{j , pix}^{2 D} ) . \qquad ( 11 )$$

The final rendered color (Cₚᵢₓ) for each pixel is computed as a weighted sum of the colors of each Gaussian (cᵢ=[rᵢ gᵢ bᵢ]^{T}), with weights determined by the Gaussian's influence on that pixel ƒ_{j,pix}^{2D} (the equivalent of the formula for ƒᵢ in 3D except with the 3D means and covariance matrices replaced with the 2D splatted versions), and down-weighted by an occlusion (transmittance) term taking into account the effect of all Gaussians in front of the current Gaussian.

In one or more implementations, the rendering at 738 and/or 750 may also involve the use of machine learning models for tasks like image synthesis, shading, or texture mapping. Advanced rendering techniques employed by the rendering engine 423 may utilize neural networks or other models to improve the quality of the final rendered images.

In one or more implementations, the scene and human avatar are optimized jointly. In one or more implementations, joint optimization facilitates to alleviate the floating Gaussian artifacts for the scene and acquire sharper boundaries for the parametric human body model. In one or more implementations, the rendering engine 423 may use the adaptive control of Gaussians to get a denser set that better represents the scene. During optimization, the rendering engine 423 may employ image-based rendering losses together with human-specific regularizations during training of the ML model 220. In one or more implementations, these losses can be defined as [symbol] _{LBS}=∥W−Ŵ∥2. In one or more other implementations, these losses may be defined as follows:

$$ℒ = {λ}_{1} {ℒ}_{1} + {λ}_{2} {ℒ}_{ssim} + {λ}_{3} {ℒ}_{vgg} + {ℒ}_{proj} + {λ}_{1} {ℒ}_{1}^{h} + {λ}_{2} {ℒ}_{ssim}^{h} + {λ}_{3} {ℒ}_{vgg}^{h} + {λ}_{4} {ℒ}_{LBS} . \qquad ( 12 )$$

In this equation, [symbol] ₁ is the [symbol] ₁ loss between the rendered and ground-truth image, [symbol] ₛₛᵢₘ is the [symbol] ₛₛᵢₘ loss between the rendered and ground-truth image, and [symbol] _{vgg} is the perceptual loss between the rendered and ground-truth image. In one or more implementations, the rendering engine 423 may use two regularizer losses on the human subject Gaussians [symbol] ₚᵣₒⱼ and [symbol] ᵣₑₚ. In one or more implementations, [symbol] ₚᵣₒⱼ enforces the Gaussian means to be μ close to the local tangent plane of neighboring points by computing the PCA in a local neighborhood. In one or more implementations, [symbol] ᵣₑₚ enforces Gaussians to be close to each other in a local neighborhood. In one or more implementations, there may be λ coefficients for each loss term presented here, but are removed from Equation 12 for brevity without departing from the scope of the present disclosure. Finally, the ML model 220 may use an Adam optimizer with learning rate 1^{e-3} for decoder networks and G_{embed} with a cosine learning rate scheduling.

FIG. 8 conceptually illustrates an example visualization of human subject pose renderings in canonical shape under different configurations of the neural rendering framework in accordance with one or more implementations of the subject technology. For example, the first row includes a first subject (denoted as subject 1) in a front pose in a canonical shape, the second row includes a second subject (denoted as subject 2) in a front pose in a canonical shape, and the third row includes the second subject in a back pose in a canonical shape.

In one or more other implementations, a fixed number of Gaussians can be retained throughout the optimization process, as depicted in configurations 810 and 830 (denoted as Configuration 3) in FIG. 8. In configuration 830, certain Gaussians may protrude from the body, leading to a suboptimal reconstruction of details, as exemplified by the boot laces in the second row.

In one or more implementations, the optimization process directly targets the 3D Gaussian parameters instead of employing a triplane-MLP model for their learning. Individual Gaussians are deformed using LBS weights obtained through the query algorithm outlined in Eq. (5). The outcomes of this experiment are illustrated in configurations 810 and 840 (denoted as Configuration 4) in FIG. 8. In one or more implementations, optimizing each Gaussian independently can result in a tendency for the per-Gaussian colors to overfit to the training frames, leading to color artifacts and diminished quality in novel animation renderings and test frames. In one or more other implementations, the triplane-MLP model facilitates implicit regularization of color based on Gaussian position, while the learned appearance provides supplementary 3D supervision signal for Gaussian positions.

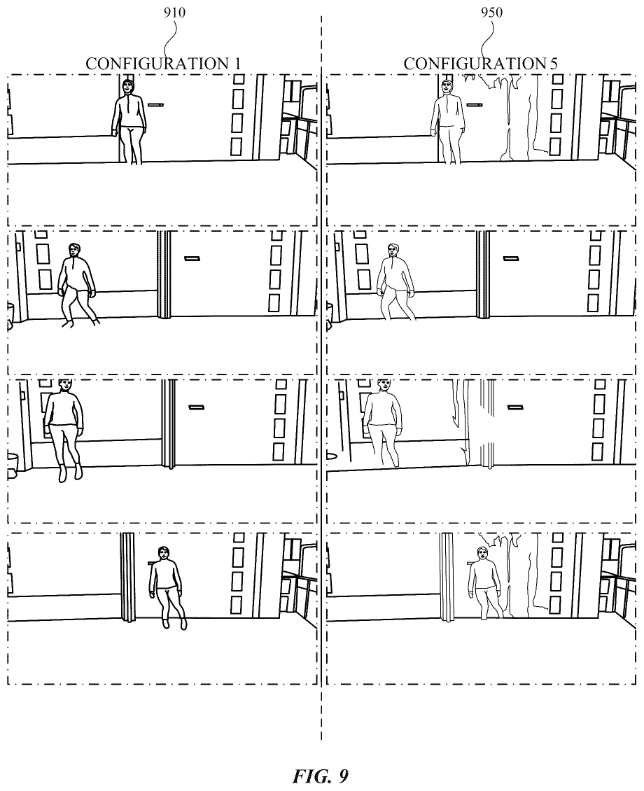

FIG. 9 illustrates example neural rendering using joint human subject and scene optimization and neural rendering using separate human subject and scene optimization in accordance with one or more implementations of the subject technology. The impact of jointly optimizing human and scene models can be illustrated in FIG. 9. In one or more implementations, configuration 910 (denoted as Configuration 1) represents human and scene Gaussians separately, but the optimization is conducted jointly. In one or more other implementations, configuration 950 (denoted as Configuration 5) involves initially optimizing the scene by masking out human regions and then optimizing the human Gaussians. In one or more other implementations, as demonstrated in the configuration 950, this configuration can lead to floating Gaussians in the scene due to sparse input views. Conversely, when human and scene optimization is performed jointly, the human subject can act as a constraint for scene reconstruction, reducing the occurrence of floating Gaussians and resulting in cleaner rendered images, as depicted in the configuration 910 of FIG. 9.

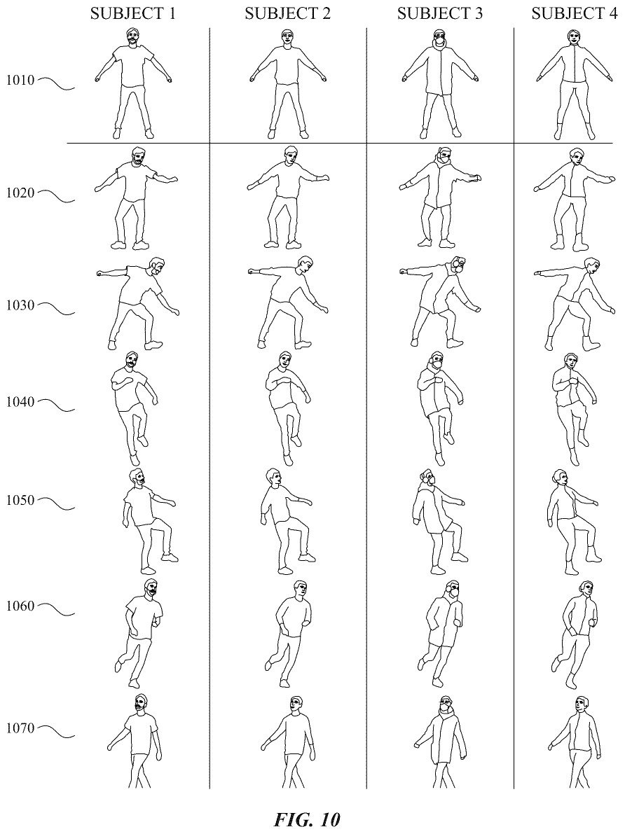

FIG. 10 illustrates example novel pose renderings of human subjects in accordance with one or more implementations of the subject technology. In one or more implementations, row 1010 depicts multiple human subjects (e.g., subject 1, subject 2, subject 3, subject 4) rendered in a reference pose. In accordance with one or more implementations of the subject technology, each of the human subjects can be rendered into novel poses relative to the reference pose rendering in row 1010. For example, each of rows 1020-1070 depicts a different pose rendering such that each of the subjects in the respective row is depicted in a common pose for purposes of illustrating that a subject in a first pose can be reconstructed into a second pose different from the first pose based at least in part on aspects of the subject technology.

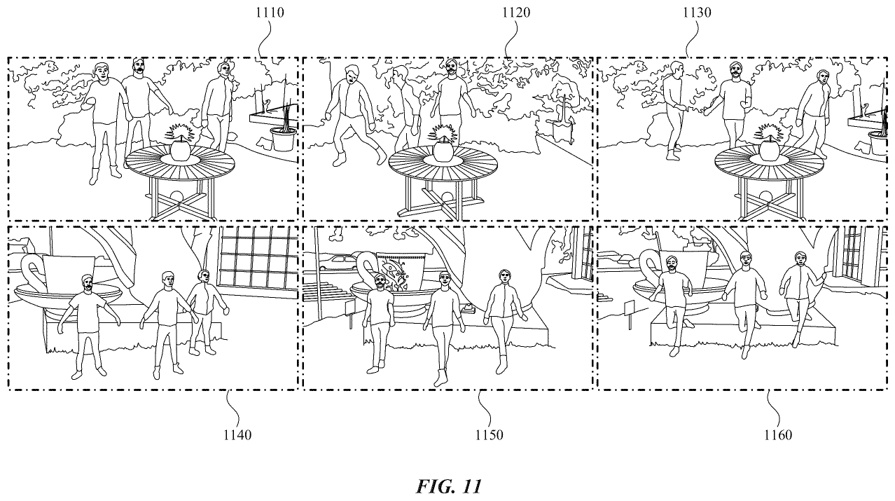

FIG. 11 illustrates example images depicting animation of multiple human subjects in novel scenes in accordance with one or more implementations of the subject technology. For example, FIG. 11 showcases the composition of multiple animated subjects in various scenes (e.g., scenes 1110-1160). In one or more implementations, the renderings illustrated in FIG. 11 can be obtained by transferring the Human Gaussians to different scenes. In one or more implementations, the poses of the animated subjects can be obtained from an Archive of Motion Capture as Surface Shapes (AMASS) motion capture dataset. In one or more implementations, the AMASS dataset is a large-scale motion capture dataset that contains 4D surface motion capture data of human subjects. This dataset can provide high-quality motion capture data in the form of 3D body meshes along with corresponding motion parameters such as joint angles and body shape.

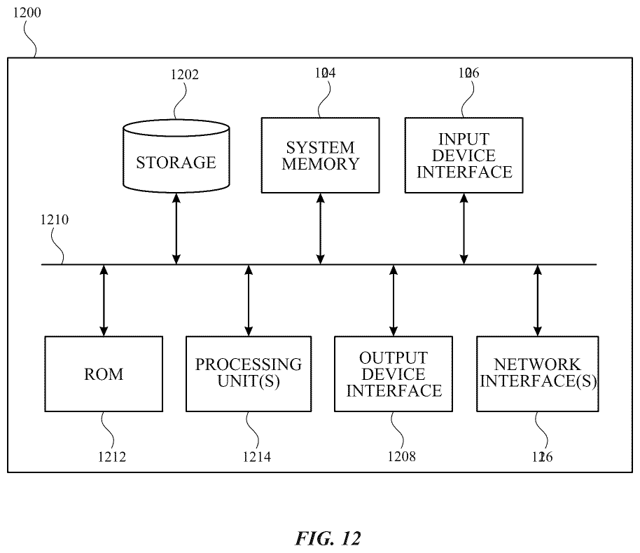

FIG. 12 illustrates an example computing device with which aspects of the subject technology may be implemented in accordance with one or more implementations. The computing device 1200 can be, and/or can be a part of, any computing device or server for generating the features and processes described above, including but not limited to a laptop computer, a smartphone, a tablet device, a wearable device such as a goggles or glasses, and the like. The computing device 1200 may include various types of computer readable media and interfaces for various other types of computer readable media. The computing device 1200 includes a permanent storage device 1202, a system memory 1204 (and/or buffer), an input device interface 1206, an output device interface 1208, a bus 1210, a ROM 1212, one or more processing unit(s) 1214, one or more network interface(s) 1216, and/or subsets and variations thereof.

The bus 1210 collectively represents all system, peripheral, and chipset buses that communicatively connect the numerous internal devices of the computing device 1200. In one or more implementations, the bus 1210 communicatively connects the one or more processing unit(s) 1214 with the ROM 1212, the system memory 1204, and the permanent storage device 1202. From these various memory units, the one or more processing unit(s) 1214 retrieves instructions to execute and data to process in order to execute the processes of the subject disclosure. The one or more processing unit(s) 1214 can be a single processor or a multi-core processor in different implementations.

The ROM 1212 stores static data and instructions that are needed by the one or more processing unit(s) 1214 and other modules of the computing device 1200. The permanent storage device 1202, on the other hand, may be a read-and-write memory device. The permanent storage device 1202 may be a non-volatile memory unit that stores instructions and data even when the computing device 1200 is off. In one or more implementations, a mass-storage device (such as a magnetic or optical disk and its corresponding disk drive) may be used as the permanent storage device 1202.

In one or more implementations, a removable storage device (such as a flash drive and its corresponding solid-state drive) may be used as the permanent storage device 1202. Like the permanent storage device 1202, the system memory 1204 may be a read-and-write memory device. However, unlike the permanent storage device 1202, the system memory 1204 may be a volatile read-and-write memory, such as random access memory. The system memory 1204 may store any of the instructions and data that one or more processing unit(s) 1214 may need at runtime. In one or more implementations, the processes of the subject disclosure are stored in the system memory 1204, the permanent storage device 1202, and/or the ROM 1212. From these various memory units, the one or more processing unit(s) 1214 retrieves instructions to execute and data to process in order to execute the processes of one or more implementations.

The bus 1210 also connects to the input and output device interfaces 1206 and 1208. The input device interface 1206 enables a user to communicate information and select commands to the computing device 1200. Input devices that may be used with the input device interface 1206 may include, for example, alphanumeric keyboards and pointing devices (also called “cursor control devices”). The output device interface 1208 may enable, for example, the display of images generated by computing device 1200. Output devices that may be used with the output device interface 1208 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information.

One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 12, the bus 1210 also couples the computing device 1200 to one or more networks and/or to one or more network nodes through the one or more network interface(s) 1216. In this manner, the computing device 1200 can be a part of a network of computers (such as a LAN, a wide area network (“WAN”), or an Intranet, or a network of networks, such as the Internet. Any or all components of the computing device 1200 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components (e.g., computer program products) and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method comprising:
receiving a video input comprising a scene and a subject;
obtaining a three-dimensional (3D) reconstruction of the subject and the scene from the video input;
generating a 3D Gaussian representation of each of the scene and the subject;
generating a deformed 3D Gaussian representation of the subject by adapting the 3D Gaussian representation of the subject to the 3D reconstruction of the subject; and
rendering a visual output comprising at least one of an animatable avatar of the subject or the scene based at least in part on the deformed 3D Gaussian representation of the subject and the 3D Gaussian representation of the scene.

2. The method of claim 1, wherein the obtaining the 3D reconstruction of the subject and the scene comprises performing a structure-from-motion operation and pose estimation to a sequence of frames in the video input to obtain point cloud data of the scene and the 3D reconstruction of the subject.

3. The method of claim 2, wherein the structure-from-motion operation and the pose estimation are performed concurrently.

4. The method of claim 1, wherein the generating the deformed 3D Gaussian representation comprises applying a forward deformation module to facilitate learning of pose correctives and linear skinning weights.

5. The method of claim 4, wherein the deformed 3D Gaussian representation is generated based at least in part on the pose correctives and the linear skinning weights.

6. The method of claim 5, wherein the generating the deformed 3D Gaussian representation of the subject comprises applying the pose correctives to the 3D Gaussian representation of the subject.

7. The method of claim 6, wherein the generating the deformed 3D Gaussian representation of the subject comprises applying the linear skinning weights to the 3D Gaussian representation of the subject applied with the pose correctives.

8. The method of claim 1, wherein the visual output comprising the at least one of the animatable avatar of the subject or the scene is rendered using differentiable Gaussian rasterization.

9. A device, comprising:
a memory; and
one or more processors configured to:
receive a video input comprising a scene and a subject;
obtain point cloud data of the scene and a three-dimensional (3D) reconstruction of the subject;
generate a 3D Gaussian representation of each of the scene and the subject;
generate a deformed 3D Gaussian representation of the subject by adapting the 3D Gaussian representation of the subject to a specific pose and shape of the subject from the 3D reconstruction of the subject; and
render a visual output comprising at least one of an animatable avatar of the subject or the scene using differentiable Gaussian rasterization based at least in part on the deformed 3D Gaussian representation of the subject and the 3D Gaussian representation of the scene.

10. The device of claim 9, wherein the one or more processors configured to obtain the point cloud data and the 3D reconstruction of the subject are further configured to perform a structure-from-motion operation and pose estimation to a sequence of frames in the video input to obtain the point cloud data of the scene and the 3D reconstruction of the subject.

11. The device of claim 10, wherein the structure-from-motion operation and the pose estimation are performed concurrently.

12. The device of claim 9, wherein the one or more processors configured to generate the deformed 3D Gaussian representation of the subject are further configured to apply a forward deformation module to facilitate learning of pose correctives and linear skinning weights.

13. The device of claim 12, wherein the deformed 3D Gaussian representation is generated based at least in part on the pose correctives and the linear skinning weights.

14. The device of claim 13, wherein the one or more processors configured to generate the deformed 3D Gaussian representation of the subject are further configured to apply the pose correctives to the 3D Gaussian representation of the subject.

15. The device of claim 14, wherein the one or more processors configured to generate the deformed 3D Gaussian representation of the subject are further configured to apply the linear skinning weights to the 3D Gaussian representation of the subject applied with the pose correctives.

16. A non-transitory computer-readable medium storing instructions that, when executed by one or more processors, cause the one or more processors to:
receive a video input comprising a scene and a subject;
apply structure-from-motion and pose estimation to a sequence of frames in the video input to obtain point cloud data of the scene and a three-dimensional (3D) reconstruction of the subject;
generate a 3D Gaussian representation of each of the scene and the subject;
generate a deformed 3D Gaussian representation of the subject by adapting the 3D Gaussian representation of the subject to a specific pose and shape of the subject from the 3D reconstruction of the subject; and
render a visual output comprising at least one of an animatable avatar of the subject or the scene using differentiable Gaussian rasterization based at least in part on the deformed 3D Gaussian representation of the subject and the 3D Gaussian representation of the scene.

17. The non-transitory computer-readable medium of claim 16, wherein the structure-from-motion and the pose estimation are performed concurrently.

18. The non-transitory computer-readable medium of claim 16, wherein the instructions that cause the one or more processors to generate the deformed 3D Gaussian representation of the subject further cause the one or more processors to apply a forward deformation module to facilitate learning of pose correctives and linear skinning weights.

19. The non-transitory computer-readable medium of claim 18, wherein the deformed 3D Gaussian representation is generated based at least in part on the pose correctives and the linear skinning weights.

20. The non-transitory computer-readable medium of claim 19, wherein the instructions that cause the one or more processors to generate the deformed 3D Gaussian representation of the subject further cause the one or more processors to apply the pose correctives to the 3D Gaussian representation of the subject, wherein the instructions that cause the one or more processors to generate the deformed 3D Gaussian representation of the subject further cause the one or more processors to apply the linear skinning weights to the 3D Gaussian representation of the subject applied with the pose correctives.
